(19) United States
(12) Patent Application Publication
(10) Pub. No.: US 2006/0036857 A1
(43) Pub. Date: Feb. 16, 2006

(54) User authentication by linking randomly-generated authentication secret with personalized secret

(76) Inventor: Jing-Jang Hwang, Tao-Yuan (TW)

Correspondence Address: FISH & RICHARDSON, PC, P.O. BOX 1022, MINNEAPOLIS, MN, 55440-1022, US

(21) Appl. No.: 11/197,888

(22) Filed: Aug. 4, 2005

Related U.S. Application Data
(60) Provisional application No. 60/599,392, filed on Aug. 6, 2004.

(51) Int. Cl. H04L 9/00

(52) U.S. Cl. 713/168

(57) ABSTRACT

This patent application discloses techniques, devices and systems for user authentication based on linking between a randomly generated authentication secret and a personalized secret.

### CROSS REFERENCE TO RELATED PATENT APPLICATION

This Application claims a Priority Filing Date of Aug. 6, 2004 benefited from a previously filed U.S. Provisional Patent Application No. 60/599,392 entitled “User Authentication by Linking Randomly-Generated Authentication Secret with User-Chosen Secret Password” filed by the same inventor of this Application.

### BACKGROUND

This patent application relates to user authentication in various computer-based devices, systems and networks.

Many user authentication techniques and systems are based on passwords. In computer and communication networks, a user often requests accesses to systems such as various servers that provide services by banks or other merchants. Often, a user registers with a system a password and his personal identification such as a user identifier. The personal identification and password a user registered may be different from system to system. To access a system, a user must prove that he knows a valid identifier/password pair that was registered or updated.

In conventional terms, a user requests an access from a terminal, a client site, a user site, a user device, or a user station while the accessed system is called a server, a computer system, a system station, a system site, a system device, or simply a system.

Authentication is the process of determining whether a claimed identity is valid. Using identifier/password pairings for user authentication is probably the most widely used method in information systems. Of course, passwords should not be stored in plaintext in an authentication database in a system to prevent from disclosure. Instead, a password is processed with a transformation function and the value derived is stored. When a user wants to gain access from a user station, the processor at the user site can perform the same transformation function on the password the user supplies and then send the derived value to the accessed system to be compared to the previously stored derived value. The transformation function chosen for this purpose must be collision-free or collision-resistant so that it is impossible or near impossible to find two different passwords to produce one derived value. Furthermore, the transformation function must be computationally irreversible so that an output of the transformation cannot give clues about what the input password is. Several functions possess these properties, most notable being one-way hash functions such as MD2, MD5, SHA-1, SHA-256, SHA-384, and SHA-512. Many systems have adopted these one-way hash functions in the implementation of this password-based authentication method. Various versions of the UNIX Operating System are prime examples.

The basic password-based scheme described above, which was implemented in UNIX, is an early solution to user authentication. This solution is vulnerable to one form of attack—the replay attack. Attackers can record messages sent from a user station to an accessed system and, at a later time, replay those messages and gain accesses to user accounts in the accessed system.

In various more advanced authentication systems, the basic password-based scheme has been modified so that the conversation between a user station and the accessed system is different for each authentication session. The replay of an old authentication conversation cannot succeed, due to the uniqueness of the conversation for each authentication. In the revised method, it is assumed that for every registered user a pair of a user identifier and a password-derived hash value is stored in an authentication database. The authentication process is carried out as follows. At the user site, a user enters a password. The entered password is run through the same one-way hash function to produce a new hash value. The resulting hash and the entered password are not sent to the accessed system. Instead, the assessed system creates a random number as a challenge, which is used to challenge the user station to prove that the new hash value is produced from a valid password. The challenge is sent to the user site from the accessed system. The processor at the user site encrypts the received challenge with the new hash value as the encryption key to produce a response, which is then sent to the accessed system. Upon receiving, the accessed system decrypts the response with the stored hash value associated with this claimed user as the decryption key to obtain a result. The authentication succeeds if the result matches with the challenge.

In this method, the computed hash value on the user side and the stored hash value in the accessed system are, respectively, an encryption key and a decryption key in a symmetric-key cryptosystem. These two hash values are also called a user-side hash value and a registered hash value, respectively.

In a networking environment equipped with Secure Sockets Layer (SSL) or equivalents, a communication exchange such as a challenge or a response can be encrypted with a session key by the sender and then decrypted with the same session key by its receiver. The message is not transmitted in plaintext in such an environment.

In a system implemented with the method described above, how can the original copy of the hash value get into the authentication database of the accessed system? How can changes on a user password result in a corresponding change on the registered hash value in the authentication database?

One possible solution is described below. An administrator assigns a user a temporary password and the hash value of the temporary password is stored in the authentication database. The administrator will then tell the user what his/her password is through an out-of-band mechanism such as a letter or e-mail. In the meantime, a flag is set on the user's account so that the user can only login the accessed system once using the password created by the administrator.

When a user logins for the first time or logins to change his password, he is first requested to enter a user identifier and a password, a first-time or current password, for authentication and then is requested to enter a new password. Upon success of user authentication, the new password is hashed on the user station. The hash value of the new password is then encrypted using the hash value of the first time or current password and then sent to the accessed system. The accessed system decrypts the encrypted new hash value using the existing hash value, and then replaces the existing hash value with the new hash value in the authentication database. In this implementation, the administrator at the system site never knows a correct password except those created for first-time logins.

The above solution remains insecure, however. Attackers may launch dictionary attacks to guess a user password. Among various forms of dictionary attack reported, the global dictionary attack is one that is hard to defeat. Attackers try a password guess globally, i.e. try every guess on all user accounts. Attackers can carry out an off-line global dictionary attack when the authentication database is available. Such an attack is very likely to succeed, because ordinary users often choose weak passwords easy to remember by a user him/herself but can be included in a dictionary as high-prioritized guesses by attackers. On-line global dictionary attacks are another form of dictionary attack. On-line attacks by guesses are often harder to succeed if a throttling mechanism is built in the accessed system to restrict the number of attempts on one user account. But an on-line global dictionary attack may be able to bypass the throttling, because the guess attempts are globally applied to all accounts and not uninterruptedly applied to one account. As a further threat, on-line global dictionary attacks may cause the accessed system to deny services requested by legitimate users.

Another threat to password safety arises from stealing passwords by Trojan horses. Trojan horses are an intrusive programming code planted in a computer by attackers. The instructions of a Trojan horse are hidden but can do damage, while the intruded computer may appear to function normally. One type of Trojan horse can secretly record keyboard entries and then send the records to an outside computer. Such Trojan horses can steal confidential information including identifier/password pairs that are essential for access to systems. This threat imposes a great risk.

Therefore, there exists a need to strengthen computer and communication security in the user authentication process.

### SUMMARY

This application describes, among others, exemplary methods, techniques, devices and systems for implementing digital user authentication based on linking between a randomly generated authentication secret and a personalized secret. In the implementations described below, the present digital user authentication may be incorporated in various authentication systems, such as those based on the “challenge and response” scheme using a symmetric-key cryptography, to strengthen the security of the systems.

In one example, a method is described for utilizing challenge and response for the user authentication. When a user requests an access to a computer system, a first user input and a second user input from the user and a registered secret at the system are used to perform a challenge-and-response process to authorize or reject the access request.

In another example for a method of user authentication, an authentication secret is used to associate a user identifier of a user with a system identifier of a computer system; a user password from the user and the authentication secret are used as input to produce a user-side secret; the user-side secret, user identifier, and system identifier are grouped as an authenticator; and the user password and the authenticator are used to reproduce the authentication secret by a user station to reestablish the association as a basis for authenticating the user to the computer system.

In another example for a method of user authentication, a secret is used to link a user with a computer system. In a login process, a user-side verifier is used to verify whether the secret is used in processing an access request on the user side.

In yet another example for a method for digital authentication, a user device operated by an authorized user is used to produce and register a secret in a computer system. A first user input and a second user input from a user requesting to access the computer system are used to initiate a challenge from the computer system and a response from the requesting user to compare a user-side hash value computed from the first and second user inputs and the registered secret to authorize the requested access when there is a match and to reject the requested access when there is not a match.

This application also describes an article comprising a machine-readable medium that stores machine-executable instructions for user authentication. The instructions cause a machine to: send an access request to a computer system; receive a challenge message from the computer system; use a first user input, a second user input, and the challenge message as input to a transformation to produce a response message; send the response message and a user identifier to the computer system; and receive an access decision from the computer system, wherein the access decision, either a permission or a denial, is determined by the computer system according to a registered secret associated with the user identifier.

The above and other examples, implementations and their variations are now described in greater detail in the attached drawings, the detailed description and the claims.

### BRIEF DESCRIPTION OF DRAWINGS

FIGS. 1, 2, 3A and 3B show an example of two processes in a registration process for a user authentication.

FIGS. 4 and 5 show examples for user authenticators.

FIGS. 6 and 7 show two examples of processing the user authentication with and without a user side verification, respectively.

FIG. 8 shows an example of a process for preparing information for user authentication at the user side in both FIGS. 6 and 7.

FIG. 9 shows an example of the user side validation shown as one task in FIG. 7.

FIG. 10 illustrates an example of the challenge and response process suitable for implementing FIGS. 6 and 7.

FIG. 11 shows an example of the process of updating the user's secrets created in the registration process as shown in FIGS. 1, 2, 3A, and 3B and used in the login process as shown in FIGS. 6, 7, 8, 9, and 10.

FIG. 12 shows one example of a processing for changing the authentication secret and updating the registered secret shown as one task in FIG. 11.

FIG. 13 schematically illustrates the linking role of the authentication secret in associating various identification and secret data for user authentication.

### DETAILED DESCRIPTION

Various implementations of user authentication described in this application include the following two features. Firstly, the role of password in the conventional challenge-and-response scheme is replaced with a strong authentication secret without modifying the underlying communication protocol and making a change on the processing and data structure at the system site. The strong authentication secret can be a number generated by a random number generator or a pseudorandom number generator. Secondly, the authentication secret, on the user side, is replaced with two user secrets. The first user secret is called a personalized secret, expressed as S_{P}, which can be a user-selectable password or other personal selections. The second user secret is called a user-side secret, expressed as S_{U}, which is an outcome of partitioning the authentication secret and is kept in persistent memory.

The first feature strengthens the security without paying a price on modifying the system infrastructure. The second feature also strengthens the security, though with a cost. The cost is that user must be equipped with a mobile device to memorize the user-side secret S_{U} in order to achieve the same mobility as that benefited from the conventional user authentication with password. Such a cost is acceptable, because mobile or portable devices such as cell phones and various memory or IC (Integrated Circuit) cards have been getting popular. Importantly, the strengthening on security is substantial. The new features harden attacks because attackers must guess a strong secret or discover both of the user's two secrets for a successful break-in. It is a classical wisdom that splitting a secret into two segments and separately safeguarding each will significantly strengthen the protection for the secrecy.

The methods for partitioning and recovering an authentication secret based on three transformation functions f1, f2, and f3 are described in the U.S. patent application Publication 2005/0081041 entitled “Partition and Recovery of a Verifiable Secret” by the same inventor. At an abstract level, the concept of splitting a secret into two half secrets is also utilized in the U.S. patent application Ser. No. ______, entitled “RSA with Personalized Secret,” filed on Jul. 1, 2005 by the same inventor. The entire disclosures of the above two patent documents are incorporated herein by reference as part of the specification of this application.

The techniques described in the patent application Publication 2005/0081041 partition a protected digital secret, by computation, into two digital segments—one secret-dependent digital segment and one secret-independent digital segment. The same digital secret is recovered, also by computation, upon receiving these two segments. The partition process consists of the following steps in sequence: (1) selecting a personalized secret, (2) computing the secret-independent digital segment from the personalized secret by a first transformation function, which is expressed as f1, (3) computing the secret-dependent digital segment from the secret-independent digital segment and the protected secret by a second transformation function, which is expressed as f2, and (4) storing the secret-dependent digital segment in a storage device with persistent memory. Through this process, the protected secret is split into two digital segments.

The recovery process begins with receiving an input provided as the personalized secret that is previously selected as the input to the partition process. Next, the recovery process proceeds to compute a temporary value from the received input by the first transformation function f1 and retrieve the secret-dependent digital segment from its storage. The recovery process recovers the secret from the temporary value and the retrieved secret-dependent digital segment by a third transformation function, which is expressed as f3. The temporary value is the secret-independent digital segment if the received input is correct, i.e. the received input is identical to the personalized secret.

The core of the above published patent application includes the configurations of the three transformation functions: f1, f2, and f3. One way of configuring f1, f2, and f3 to satisfy the requirements for partition and recovery of a verifiable secret is given below:
(1) U=f1(x)=λ(x)+8, where x is an input variable receiving an instance of the personalized secret, λ is a collision-free or collision-resistant function, β is a non-negative integer, and U is the output of this transformation given x as the input;
(2) V=f2(f1(x), S)=(f1(x)+α×S) mod q, where x again is an input variable receiving an instance of the personalized secret, S is the secret under protection, q is a chosen integer greater than all instances of S, α is a chosen positive integer relatively prime to q, and V is the output of the second transformation function f2 given f1(x) and S as two inputs; and
(3) S=f3(f1(x), V)=(α⁻¹×V+((−(α⁻¹×f1(x) mod q)) mod q)) mod q, where f1(x), V, q, α, and S are as defined above, and α⁻¹ represents the multiplicative inverse of α in the modular arithmetic, modulo q.

Selection of the personalized secret is flexible, provided that f1 is properly configured. For example, the personalized secret may be a user-selectable or user-chosen password, a PIN (Personal Identification Number), or a combination of several secrets such as a concatenation of a user password and a device-specific code.

Applying the above partition and recovery techniques to the implementations for user authentication in this application, the first user secret S_{P} is an independent input to f1. Accordingly, the user is allowed to discretionarily select this secret. Passwords are an easy-to-remember selection. Given f1 as a collision-resistant hash function, the selection is very flexible. For example, the selection can be a digital secret of any length<2⁶⁴ bits given that f1(x)=SHA-1(x). Such flexibility creates many application scenarios. For example, this first user secret S_{P} can be a concatenation of a user-selectable password and a device-specific code such that login can be restricted to using a specific device. As a second example, digitalized data of the user's biological characteristics such as fingerprint can be included as a part or the whole of S_{P}. In some implementations, S_{P} can be a combination of a plurality of secrets. As an example, Sp may be a combination of at least two of a user-chosen password, a device-specific code, and a biological feature of the authorized user. Sp is a personalized secret because personal selections such as a user password are most common form of this secret in practical implementations.

The second user secret S_{U} is an outcome of the partition process. S_{U} is called a user-side secret, because it is used on the user side in processing login requests. This secret must be kept in persistent memory. Portable devices with persistent memory are a user-convenient choice for storing this second user secret.

On the system side, the authentication database and computations for processing an access request from a user station remain the same as in a system implemented with the existing password-based methods except that every password-derived hash value is replaced by the hash value derived from an authentication secret, which is a randomly generated secret such as a random number. It is a strong secret, in contrast to a user-chosen password that is often considered as a weak secret. In the implementations described here, a user registers with an accessed system a hash value derived from a randomly generated secret instead of a hash value derived from a user-chosen password. A hash value can always be encoded as a positive integer within a certain range regardless of whether it is derived from a weak secret like a user-chosen password or from a strong secret like a random number. The selected one-way hash function determines the range of the derived hash value; for example, SHA-1 always produces a non-negative integer less than 2¹⁶⁰. Nobody is able to tell what the input to derive a known hash value is, due to computational intractability of the one-way hash function. Therefore, the replacement of a password-derived hash value by the hash value transformed from a randomly or pseudo-randomly generated secret results in no changes on the system side—no changes on the data structure of the authentication database and no changes on how the system implements the challenge-and-response process, i.e. no changes on the way a challenge is created and a received response is verified.

More specifically, this patent application describes two exemplary methods for processing a user request to access a computer system from a user station. One difference between the two exemplary methods is whether the user station executes a validation task. In the first exemplary method, the user side does not perform such a task and the accessed system performs the task. In the second exemplary method, the user site and the accessed system site each validates respective authentication information.

In the first exemplary method, a user at a user site requests an access to a computer system. The processor at the user site first recovers an authentication secret from two user inputs. The two user inputs are provided in response to the need of using the first user secret and the second user secret in the computations-of recovering the authentication secret. Next, a challenge-and-response process proceeds. The user processor executes the challenge-and-response in accordance with the same process as described in the existing password-based user authentication methods except that the hash value of the recovered authentication secret replaces the hash value of a password input as the encryption key for producing a response. The response is sent to the accessed system and is validated at the system site. According to the validation result, the system decides on whether the access is authorized or rejected.

In the second exemplary method, a user at a user site requests an access to a computer system. The processor at the user site first recovers an authentication secret from two user inputs and subsequently validates the recovered authentication secret. A challenge-and-response process follows if the validation result is positive. The two user inputs must match the first user secret and the second user secret respectively; otherwise the communication with the accessed system through challenge and response cannot proceed. In challenge and response, the user station produces a response as in the conventional manner except that the user-side hash value is a hash value of the recovered authentication secret. The response is sent to the accessed system and is validated at the system site.

Using a user-selectable password as the first user secret, i.e. the personalized secret, satisfies the needs in most implementations. As such, the first of the two user inputs is a password input. Notably, a password input is not validated against a derivative of the authentic password. What is validated is the recovered authentication secret.

In addition to the two exemplary methods for user logins, mechanisms for user registration and update may also be implemented.

The registration process comprises two tasks. In the first task, the user registers a secret along with an identifier of the user with the accessed system. The registered secret is a hash value derived from an authentication secret. In the second task, the authentication secret is replaced by two secrets on the user side—a personalized secret (i.e. the first user secret) and a user-side secret (i.e. the second user secret).

The update process allows the user to change the secrets used in the computations of processing user authentication. Three options are available: (1) changing the authentication secret and the first user secret to a new secret respectively and updating the registered secret and the second user secret accordingly; (2) changing the authentication secret to a new secret and updating the registered secret and the second user secret accordingly while keeping the first user secret unchanged; and (3) updating the second user secret by changing the first user secret to a new secret while keeping the authentication secret and the registered secret unchanged.

One feature in the various implementations described here is the use of random or pseudorandom numbers as the authentication secrets whose hash values are registered and stored in the computer systems to be accessed. Random and pseudorandom numbers and their generations are known. Details can be found in several books on cryptography including: Alfred J. Menezes, Paul C. van Oorschort, and Scott. A. Vanstone, Handbook of Applied Cryptography, CRC Press, 1997, and John E. Hershey, Cryptography Demystified, McGraw-Hill, 2003.

A true random number generator requires a naturally occurring source of randomness. Designing a hardware device or software program to exploit this randomness and produce a bit that is free of biases and correlations is a difficult task. There are a number of hardware candidates for this purpose. For example, see W. Holman, J. Connelly, and A. Dowlatabadi, “An Integrated Analog/Digital Random Noise Source,” IEEE Transactions on Circuits and Systems-I: Fundamental Theory and Applications vol. 44, no. 6, pp. 521-528, June 1997.

Designing a random number generator in software is more difficult than doing so in hardware. Processes upon which software random number generators may be based include the system clock, elapsed time between keystrokes and mouse movement, operating system values such as system load and network statistics, and so forth. A well-designed software random number generator should utilize as many good sources of randomness as are available. Each source should be sampled, and the sampled sequences should be combined using a complex mixing function; one recommended technique for achieving this is to apply a collision-resistant hash function such as SHA-1 and MD5 to a concatenation of the sampled sequences.

In many practical applications, pseudorandom bit generators are often used to substitute a true random bit generator. Replacing random numbers, pseudorandom numbers can be generated using a pseudorandom bit generator. A pseudorandom bit generator is a deterministic algorithm which, given a truly random binary sequence of length m, outputs a binary sequence of length n>>m which appears to be random. (n>>m means n is substantially larger than m.) The input is called a seed. ANSI X9.17 and FIPS 186 are two standardized methods for pseudorandom bit and number generation. Other methods include using a multiplicative congruence pseudorandom number generator.

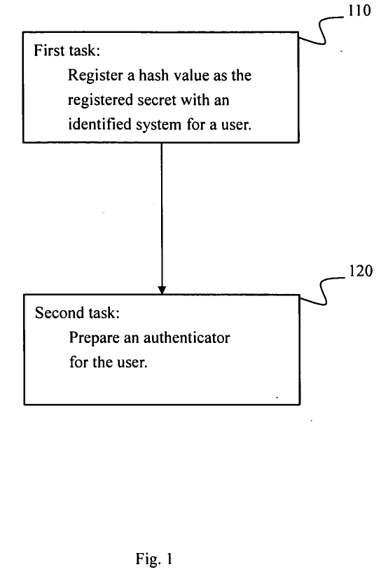

FIGS. 1 through 13 illustrate examples of some implementations. Wherever possible, the same reference numbers are used in the drawings and in the descriptions that refer to the same or like parts or processes.

FIG. 1 illustrates two major tasks of the registration process in one implementation. In the first task (task 110), a user registers a hash value as the registered secret with an identified system. In the second task (task 120), the user prepares an authenticator for usage in login processes.

In the first task, a user identifier such as an account number must be given as the user identification information or part of the user identification information. The user further requests a random or pseudorandom number as an authentication secret. The authentication secret is either provided by the accessed system or generated on a user processor. The user registers with the accessed system a user identifier and other identification data if requested and a hash value of the authentication secret. The hash value is derived from the authentication secret through a one-way hash function. In some implementations, the authentication secret and the hash value can be both produced on the user side, because the accessed system uses neither the authentication secret nor the one-way hash function in processing an access request. To decide on authorizing or rejecting an access request, the accessed system uses the registered secret, i.e. the hash value of the authentication secret, as the verification information.

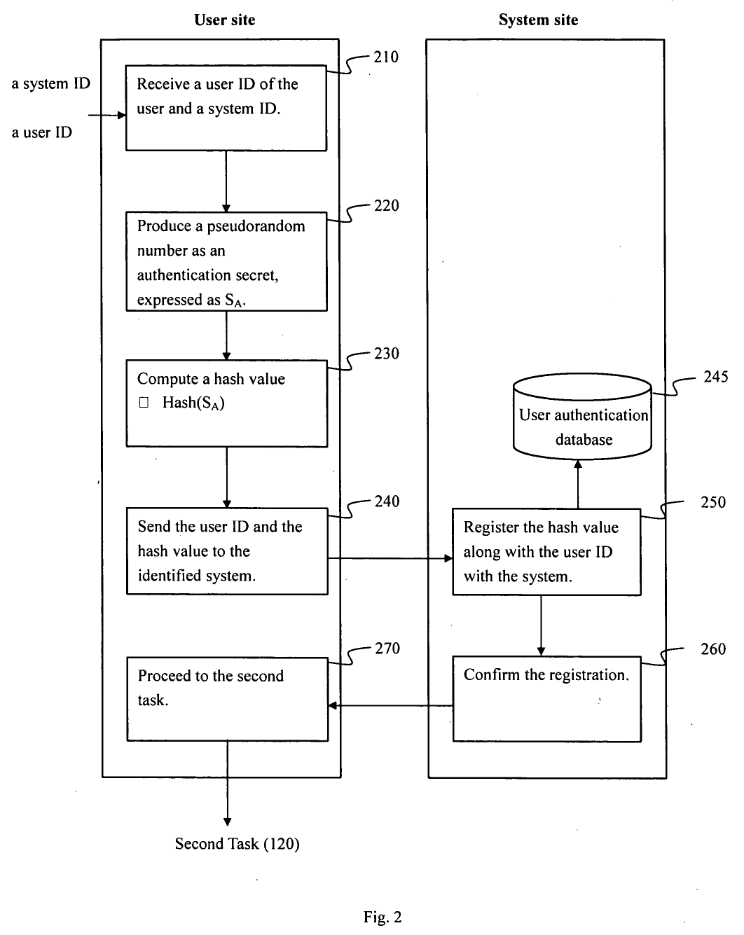

FIG. 2 shows a flowchart illustrating an exemplary process for the first task of the registration process. This exemplary process comprises the following steps: (1) at a user site, receiving a user ID and a system ID from a user, who requests an access to a computer system identified by the system ID, in step 210, (2) at the user site, producing a pseudorandom number as an authentication secret, which is expressed as S_{A}, in step 220, (3) at the user site, computing a hash value Hash(S_{A}) of the authentication secret S_{A} using a selected one-way hash function in step 230, (4) at the user site, sending the user ID and the hash value to the computer system identified by the system ID in step 240, (5) at the system site, registering the received hash value as the registered secret along with the received user ID by storing such information in a user authentication database 245 in step 250, (6) at the system site, sending a registration confirmation to the use site in step 260, and (7) at the user site, proceeding to carry out the second task (task 120) for the registration process in step 270.

The second task, carried out on the user side, is to split the authentication secret S_{A} into two secrets: (1) a personalized secret S_{P} called the first user secret, which is a personal selection of the user and is independent of the authentication secret S_{A}, and (2) a computed user-side secret S_{U}, called the second user secret, which is the main output of the second task computation using the first user secret S_{P} as an input. As a continuation of the first task, the second task also receives the authentication secret S_{A}, user ID, and system ID.

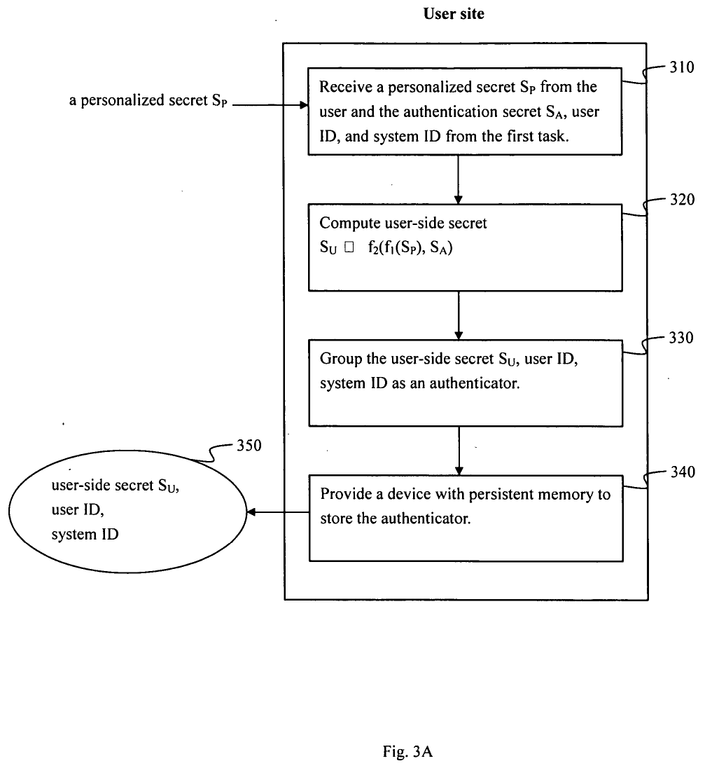

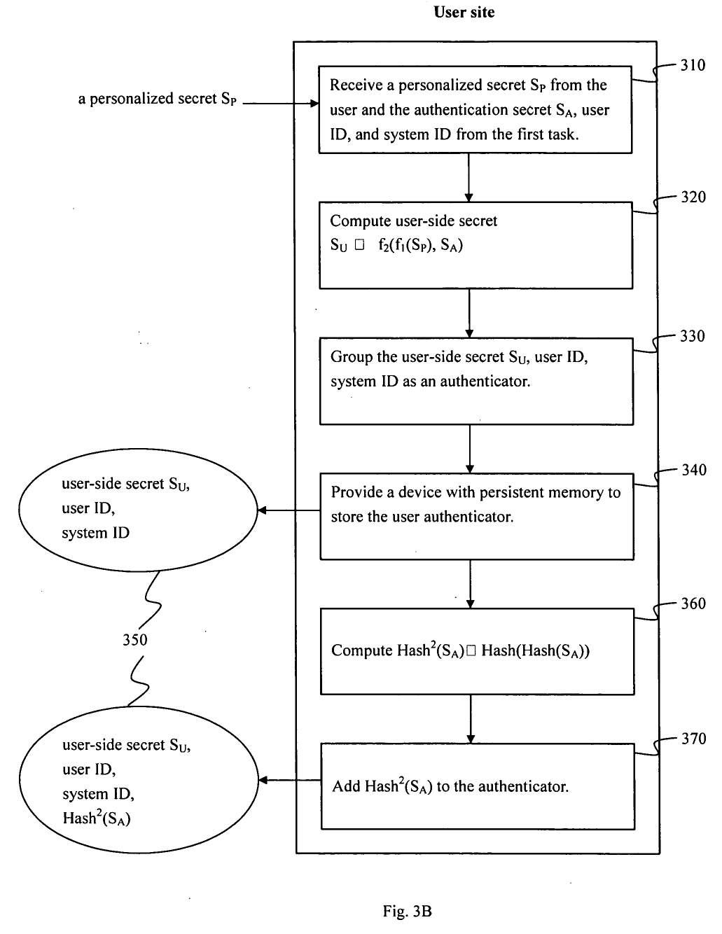

FIGS. 3A and 3B illustrate flowcharts for the second task of the registration process according to two different examples. In the first example, the second task groups the user-side secret, user ID, and system ID together as an authenticator and stores it in persistent memory. In the second example, the second task further computes a doubled-hashed value of the authentication secret, Hash(Hash(S_{A})), and adds this double-hashed value into the authenticator. The double-hashed value is prepared as the verification information for user-side validation in login processes.

In FIG. 3A, a personalized secret S_{P} is the input. The selection of this input is flexible as explained later. In step 310, the personalized secret S_{P} is input while the authentication secret S_{A}, user ID, and system ID are obtained from the first task. In step 320, a user-side secret S_{U} is obtained by computing S_{U}=f2(f1(S_{P}), S_{A}), where f1 and f2 are two functions formulated for the purpose of splitting the authentication secret. In step 330, the user-side secret S_{U}, user ID, and system ID are grouped together as an authenticator. In step 340, the authenticator is stored in a device 350 with persistent memory.

The exemplary process in FIG. 3B includes all steps in FIG. 3A but adds two further steps: 360 and 370. In step 360, a double-hashed value of the authentication secret, Hash²(S_{A})=Hash(Hash(S_{A})), is computed. In step 370, this double-hashed value is added to the authenticator in the persistent memory of the device 350.

For mobility and safety, a personal portable device like a memory card or a cell phone may be used as a storage medium for keeping the authenticator.

The double-hashed value is prepared for user-side validation. It is a user-side verifier. The reason for using Hash²(S_{A}) instead of Hash(S_{A}) as the verifier is to avoid duplication. According to the property of computational intractability of one-way hash functions, disclosure of Hash²(S_{A}) does not leak information to help guess Hash(S_{A}), which is the registered secret on the system side and must be kept confidential.

Referring back to FIGS. 3A and 3B again, the step 320 for a composite transformation, which first computes f1 and subsequently computes f2, is performed to produce the user-side secret. The function f1 is preferably a collision-resistant hash function. Computational intractability is not a necessary property f1 must posses, because it becomes unnecessary to derive the input personalized secret from the output of f1 when the output has already known to attackers. Nevertheless, configuring f1 as a collision-resistant hash function, which is computationally intractable, has a benefit. Such a configuration effectively expands the space containing all possible instances of the input to this function. For example, SHA-1 accepts a message of any length<2⁶⁴ bits as an input. (See: Federal Information Standards Publication 180-1, Secure Hash Standard, 1995.) A message of length 2⁶⁴ is very long, rendering flexibility to the selection of the personalized secret.

The flexibility on selecting a personalized secret as input to the first function f1 creates various beneficial application scenarios. For example, the secret can be a concatenation of a user-chosen password and a device-specific code such that user login can be restricted to a specific device. As a second example, digitalized data of the user's biological characteristics such as fingerprint can be included as a part or the whole of the personalized secret such that user identification by matching biological characteristics becomes a part of the login process. Other application scenarios are also possible.

The authentication secret that replaces the role of password in challenge and response can be generated as a random or pseudorandom integer less than a number like 2¹⁶⁰. Other choices are feasible, provided that the probability of successfully guessing this secret is negligible.

The second transformation function f2 in the composite transformation for computing the user-side secret in step 320 is configured as:

The user-side secret S_{U}

$$\begin{matrix}The user \text{-} side secret {S}_{U} = f2 ( f1 ( {S}_{P} ) , {S}_{A} ) \\ = ( f1 ( {S}_{P} ) + α \times {S}_{A} ) mod q ,\end{matrix}$$

where q is a constant integer greater than all possible instances of the authentication secret S_{A}, and α is a positive integer relatively prime to q. The two parameters α and q are not necessarily kept confidential.

Upon completion of a registration process, an authenticator is produced for the user. The authenticator is either a trio consisting of a system ID, a user ID, and a user-side secret S_{U} or a quadruple consisting of a system ID, a user ID, a user-side secret S_{U}, and a double-hashed value Hash²(S_{A}).

In the following, we assume that the user who requests for logins has registered at a plurality of systems. Therefore, the user owns a plurality of authenticators. The plurality of authenticators is structured with indexes such that each authenticator can be identified and retrieved with a system ID. We further assume that an accessed system has a plurality of users and thereby keeps a plurality of registered secrets. The plurality of registered secrets in a system is structured with indexes such that each registered secret can be identified and retrieved with a user ID.

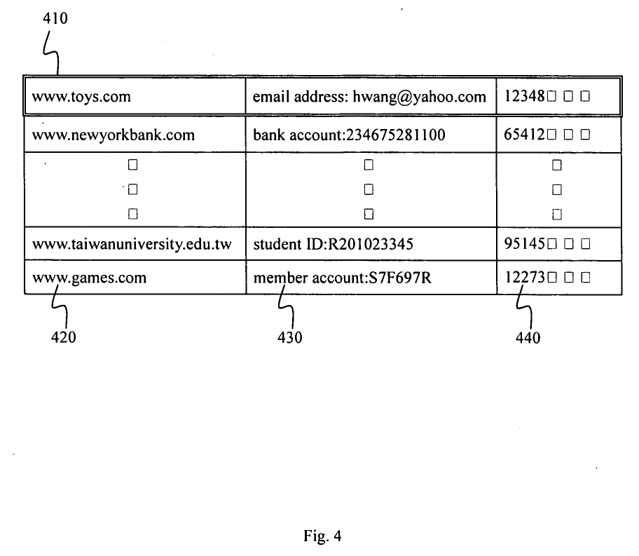

Refer to FIG. 4, which is a diagram illustrating a plurality of authenticators, where each authenticator is a trio consisting of a system ID, a user ID, and a user-side secret S_{U}. In this figure, the element 410 indicates one authenticator trio, while 420, 430, and 440 indicate, respectively, a system ID, a user ID, and a user-side secret S_{U} in one authenticator.

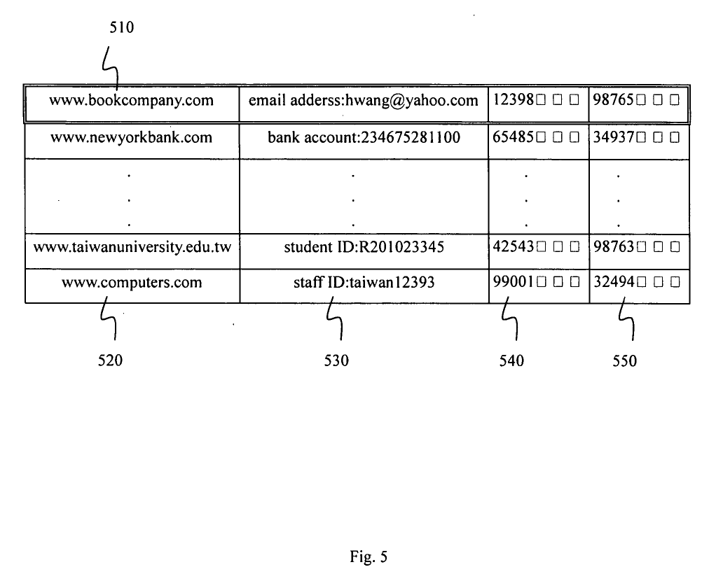

Refer to FIG. 5, which is a diagram illustrating a plurality of authenticators, where each authenticator is a quadruple consisting of a system ID, a user ID, a user-side secret S_{U}, and a double-hashed value Hash²(S_{A}). In this figure, the element 510 indicates one authenticator quadruple, while 420, 430, 440, and 450 indicate, respectively, a system ID, a user ID, a user-side secret S_{U}, and a double-hashed value Hash²(S_{A}) in one authenticator.

In a computer and communication network like the Internet, a user likely needs to access many systems. Therefore, the user needs to keep many user-side secrets, one each for the access to each system. Also, the user may register at each system using distinctive user IDs. The number of these user-side secrets and user IDs increases when the user registers at more systems. At a first glance, this appears as a drawback of the methods presented in this patent application. As illustrated in FIGS. 4 and 5, collecting a plurality of authenticators into a single file provides a solution. When a user requests an access to a system and provides an ID of the accessed system, a corresponding user-side secret and user ID can be automatically supplied to the user processor without additional efforts from the user. The file as illustrated in FIGS. 4 and 5 simplifies the input. Such a file is called a personal login file or a personal collective authenticator.

Referring back to FIGS. 3A and 3B, the device 350 for storing the produced authenticator in steps 340 and 370 is a device that stores either one single authenticator or a plurality of authenticators. In the later part of this patent specification, it is assumed that the device 350 stores a plurality of authenticators in a personal login file.

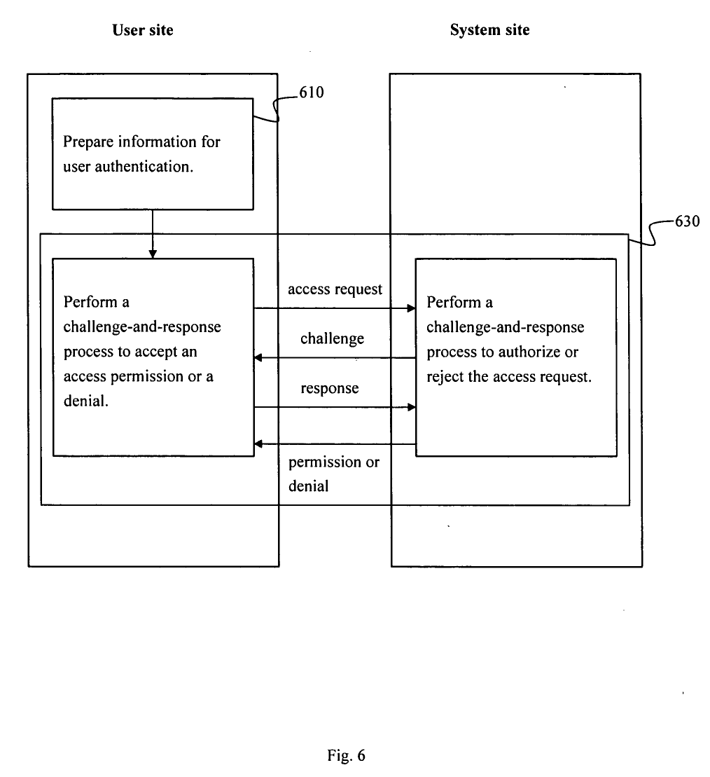

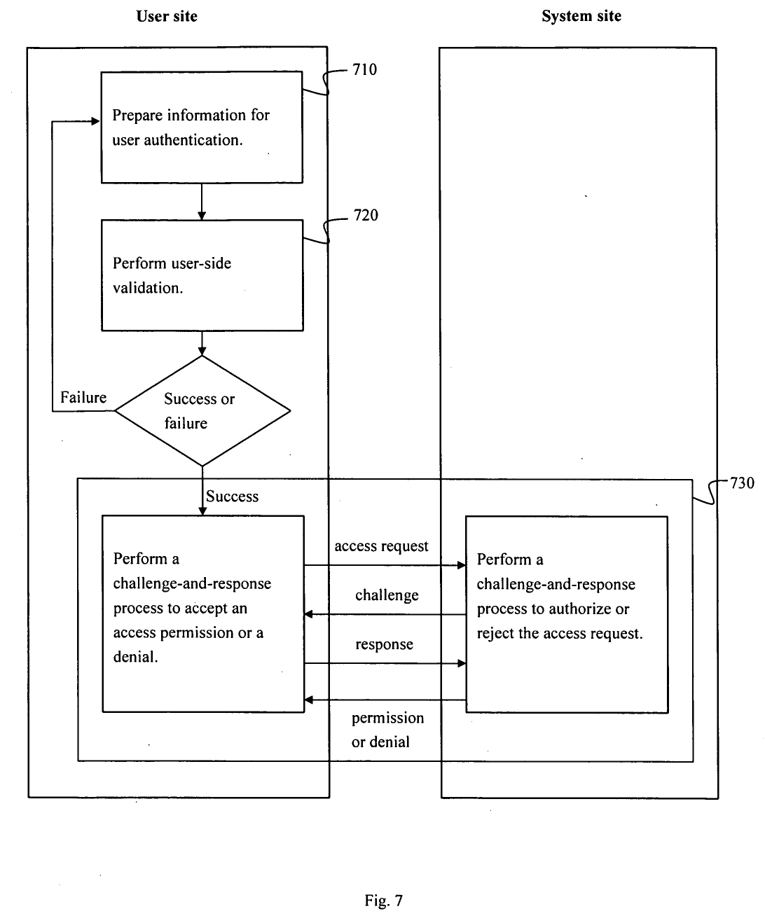

In the following, two exemplary methods for processing a user request to access a computer system are described. Refer to FIG. 6, which is a diagram illustrating the first exemplary method, and to FIG. 7, which is a diagram illustrating the second exemplary method. User-side validation is the difference between the two exemplary methods. The second exemplary method carries out one extra task for user-side validation.

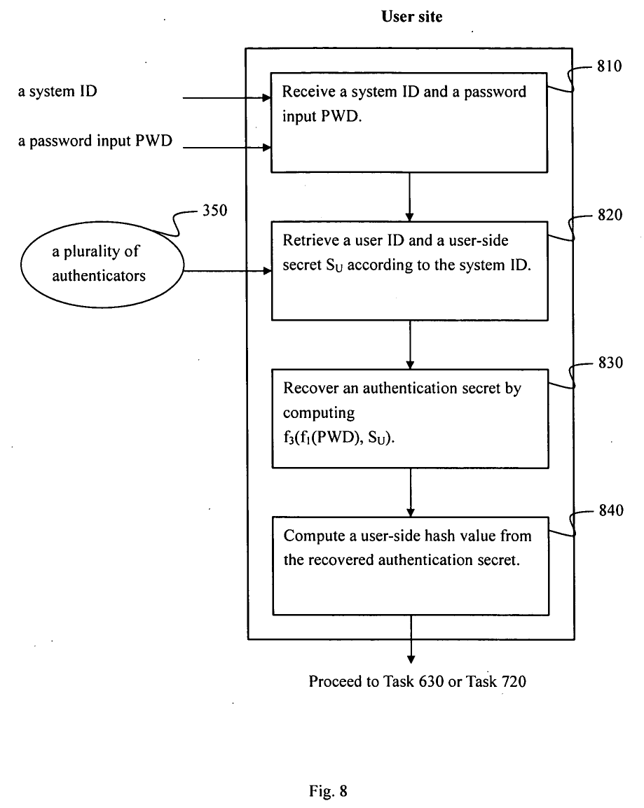

FIG. 6 shows two tasks, 610 and 630, and their sequence. In task 610, the user station receives and prepares information for task 630, which performs a challenge-and-response process. Details about 610 and 630 are illustrated in FIGS. 8 & 10, respectively.

FIG. 7 shows three tasks, 710, 720, and 730, and their relationships. In task 710, the user station receives and prepares information for user authentication. In task 720, the user station performs user-side validation. In tasks 730, the user station engages a challenge-and-response process with the accessed system. Details about tasks 710, 720, and 730 are illustrated in FIGS. 8, 9, and 10, respectively.

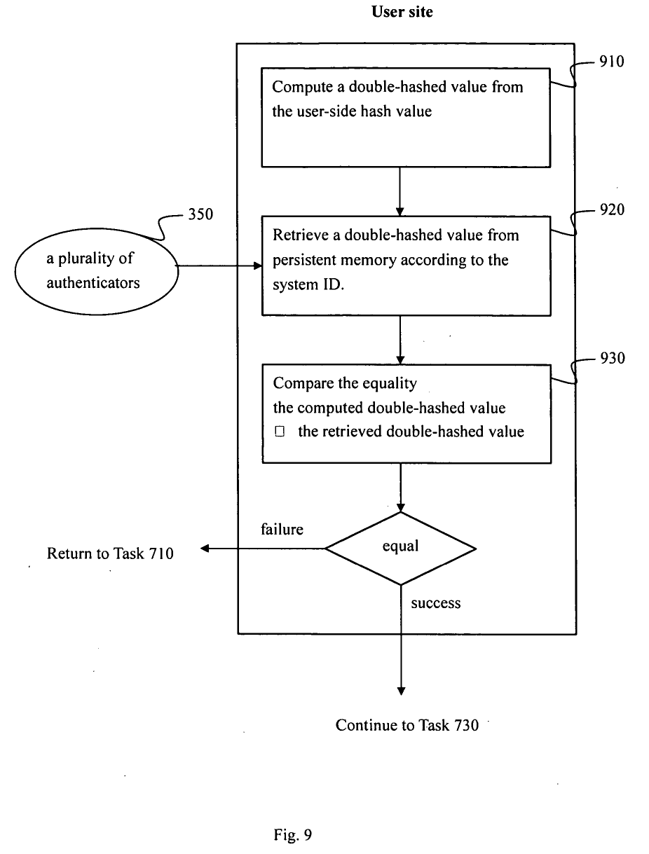

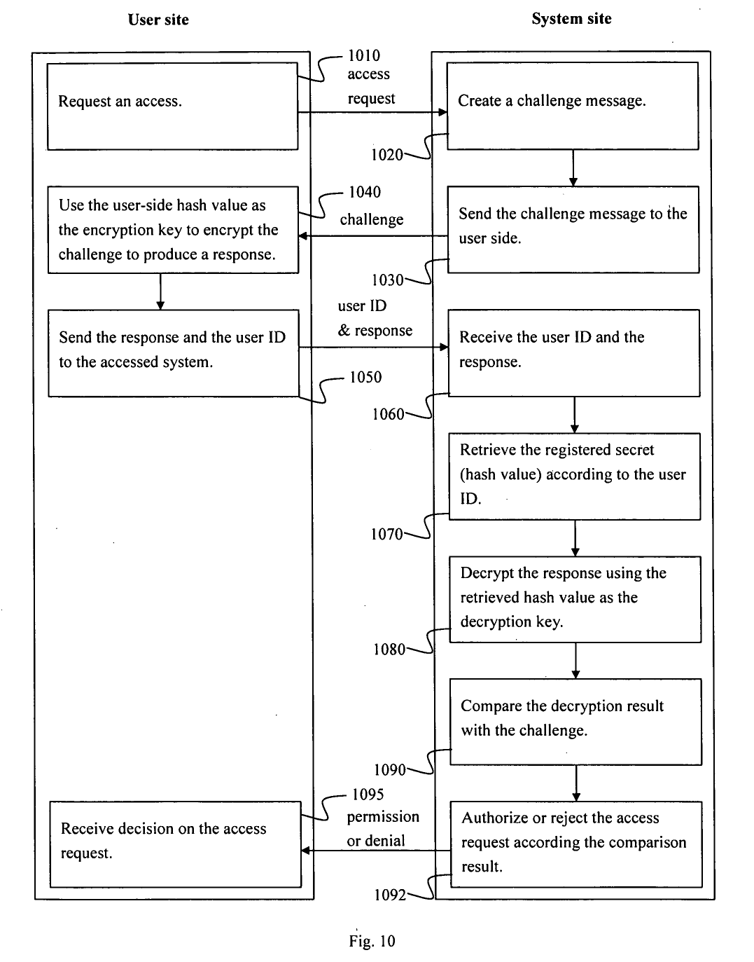

FIG. 8 shows a flowchart illustrating an exemplary process for task 610 and 710 both. Now let's assume that the personalized secret selected by the user during the registration process as shown in step 310 in FIGS. 3A and 3B is a user password. In step 810, the user station receives a password input, expressed as PWD, and a system ID from the user. In step 820, the system ID is used as an index to identify and retrieve an authenticator from the device 350, which is the device for storing a plurality of authenticators produced in the registration processes as shown in FIGS. 3A and 3B. The user-side secret S_{U} and user ID are available after this step. In step 830, the user station recovers an authentication secret by computing f3(f1(PWD), S_{U}). In step 840, the user station uses the selected one-way hash function to compute a user-side hash value from the recovered secret. Subsequently, proceed to the challenge-and-response process (task 630) as illustrated in FIG. 10 if the current task is 610, or proceed to task 720 as illustrated in FIG. 9 if the current task is 710.

The recovery computation in step 830 uses a composite transformation, which first computes f1 and subsequently computes f3. Given f1 and f2 as defined earlier, the function f3 is defined as follows:

$$\begin{matrix}{RS}_{A} = f3 ( f1 ( PWD ) , {S}_{U} ) \\ = ( {α}^{- 1} \times {S}_{U} + ( ( - ( {α}^{- 1} \times f1 ( PWD ) mod q ) ) mod q ) ) mod q ,\end{matrix}$$

where PWD is the password input received in step 810, the user-side secret S_{U} is obtained in step 820, q and α are as defined in the formulation of f2, and RS_{A} is the recovered authentication secret.

Refer to FIG. 9, which is a flowchart illustrating an exemplary process for task 720. In step 910, the user station computes a double-hashed value from the user-side hash value, which is the outcome of step 840. In step 920, the user station retrieves a double-hashed value from the storage device 350 according to the system ID received in step 810. The retrieved doubled-hash value was previously stored in the storage device 350 in step 370 as shown in FIG. 3B. In step 930, the computed double-hashed value and the retrieved double-hashed value are compared. Next, proceed to perform the challenge and response task (task 730) if the comparison yields an equal; otherwise, return to the task 710.

Now refer to FIG. 10, which a flowchart illustrating an exemplary process for task 630 and 730, i.e. the challenge-and-response process. In step 1010, the user station sends an access request to the computer system, which is identified with the system ID received from the user in step 810. In step 1020, the identified computer system receives the access request and creates a random message as a challenge. In step 1030, the system sends the challenge to the user station. In step 1040, the user station uses the user-side hash value, a result by step 840, as the encryption key to encrypt the challenge to produce a response. In step 1040, the user station sends the response and the user ID to the system, where the user ID is a result of step 820. In step 1060, the system receives the user ID and the response. In step 1070, the system identifies and retrieves the registered secret according to the user ID. In step 1080, the system decrypts the response using the retrieved registered secret as the decryption key and produces a decryption result. In step 1090, the system compares the decryption result with the challenge. In step 1092, the system decides on authorizing or rejecting the access request and sends the decision to the user station: the request is authorized when the comparison yields an equal and rejected otherwise. In step 1095, the user station receives permission or denial from the system.

According to the first and second exemplary methods as illustrated in FIGS. 8, 9, and 10, the login process receives three inputs: (1) a system ID, (2) a password input PWD, and (3) a user login file consisting a plurality of authenticators. To identify which system to request an access, the user provides the system ID. The system ID must be correct; otherwise the system cannot be identified. The second input, PWD, is an input to match the first user secret, i.e. the personalized secret. These figures illustrate a practical selection for the personalized secret for most application scenarios, using a user password as the selection. The third input, the user login file, is used to retrieve the user-side secret and the corresponding user ID registered with the accessed system. The password input PWD and the retrieved user-side secret S_{U} are two inputs to recover an authentication secret RS_{A}, which is the input to produce a user-side hash value needed to proceed the challenge-and-response task.

In case that the access request fails to pass the user-side validation in step 930 or is rejected in step 1092, there are three possibilities: (1) the input to match the personalized secret is a mismatch, (2) the authenticator retrieved from the user login file is false, and (3) both user input for the personalized secret and the authenticator are false. The case (1) is more likely to occur than others, because this input often includes a human entry such as a password entry. The user login file in most implementations is kept in a personal device; therefore, recovering a false authentication secret due to a false authenticator is much less likely. It is the user's responsibility to ensure integrity of his/her own user login file.

In conventional methods, a user is allowed to change his password without by resorting to a registration again. To enable a user to change the secrets used in the computations of processing user logins, this application provides three options for the update: (1) changing the authentication secret and the first user secret to a new secret respectively and updating the registered secret and the second user secret accordingly; (2) changing the authentication secret to a new secret and updating the registered secret and the second user secret accordingly while keeping the first user secret unchanged; and (3) updating the second user secret triggered by changing the first user secret to a new secret while keeping the authentication secret and the registered secret unchanged.

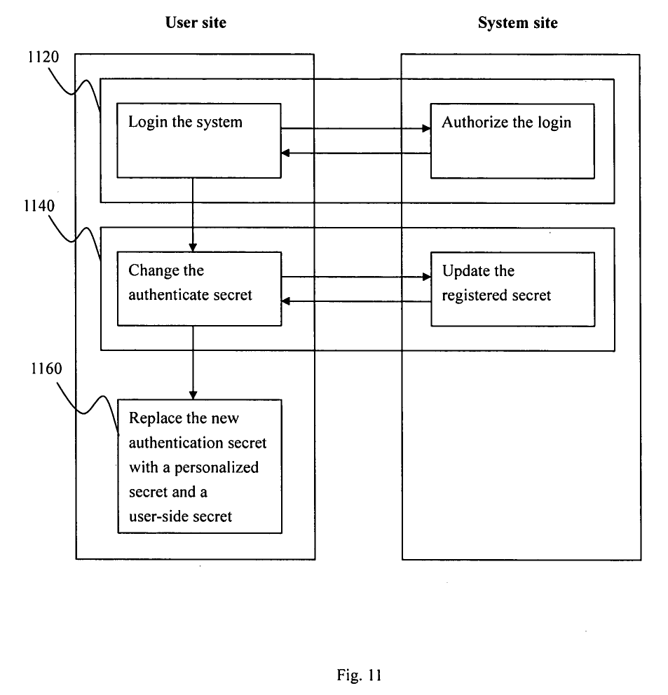

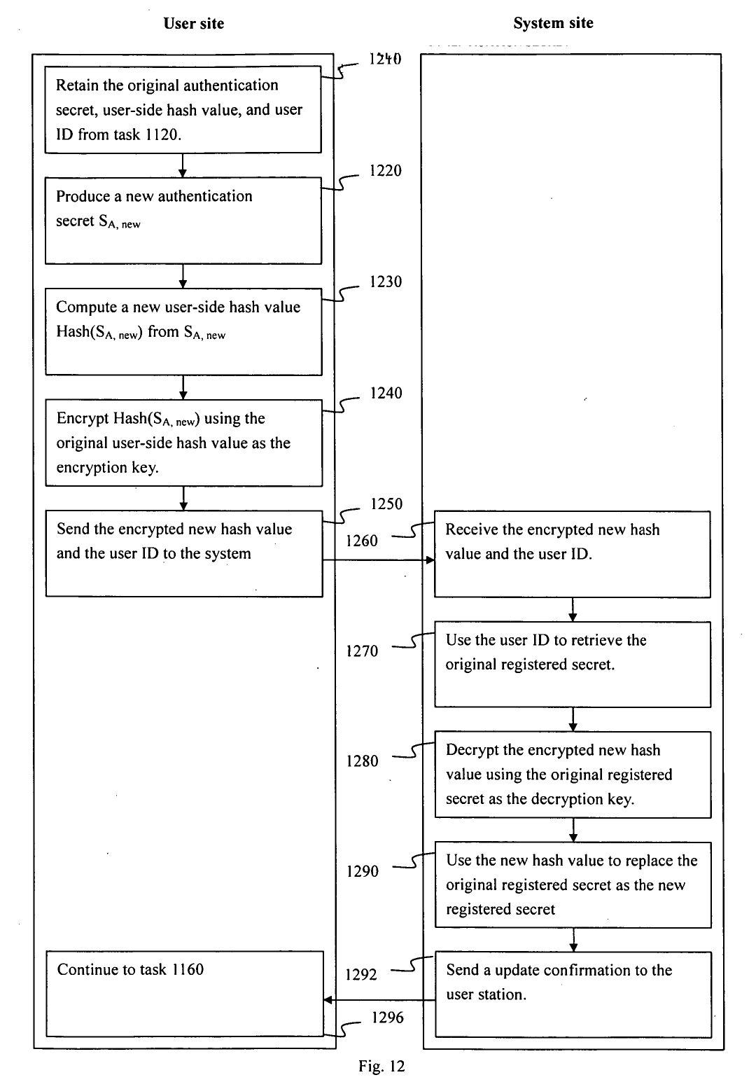

Refer to FIG. 11, which is a diagram illustrating three major tasks for the first and second update options. In task 1120, the user uses the original first and second user secrets to login a computer system, where the user wants to change the registered secret. The login processes described earlier can be applied to perform this task; duplicate descriptions are not necessary. In task 1140, the original authentication secret is changed to a new authentication secret and the registered secret is updated accordingly. The process for this task is illustrated in FIG. 12 and is described later. In task 1160, the new authentication secret is partitioned. For the first update option, a new first user secret such as a new user password is obtained and subsequently a new second user secret, i.e. a new user-side secret, is updated by computing:

The new second user secret=f2(f1(the new first user secret), the new authentication secret).

For the second update option, the original first user secret is retained while the second user secret must be updated by computing:

The new second user secret=f2(f1(the original first user secret), the new authentication secret).

Refer to FIG. 12, which is a flowchart illustrating a process for task 1140. This task can be carried out in the same way as that the hash value of an original password is replaced in accordance with the conventional password-based user authentication method. Detail steps are given below. In step 1210, the user station retains the original authentication secret, user-side hash value, and user ID from task 1120. In step 1220, the user station produces a new authentication secret, expressed as S_{A, new}. In step 1230, the user station computes a new user-side hash value Hash (S_{A, new}) from S_{A, new}. In step 1240, the user station encrypts the new user-side hash value using the original user-side hash value as the encryption key. In step 1250, the user station sends the encrypted new hash value and the user ID to the computer system. In step 1260, the system receives the encrypted new hash value and the user ID. In step 1270, the system uses the user ID to retrieve the original registered secret. In step 1280, the system decrypts the encrypted new hash value using the original registered secret as the decryption key. In step 1290, the system uses the new hash value to replace the original registered secret as the new registered secret. In step 1292, the system sends confirmation to the user station. In step 1296, the user station receives the confirmation and continues to perform task 1160, by which the new authentication secret is replaced by two user secrets on the user side.

Performing the update according to the third option, the user recovers the authentication secret presently in use and then uses a new first user secret and the recovered authentication secret as input to obtain a new second user secret. Using the same composite transformation as shown in step 320, the updated second user secret=f2(f1(the new first user secret), the recovered authentication secret)). This update can be carried out on the user side alone if user-side verification similar to that shown in FIG. 9 is performed to ensure the correctness of the recovered authentication secret. Otherwise, the user must login the system to ensure such correctness.

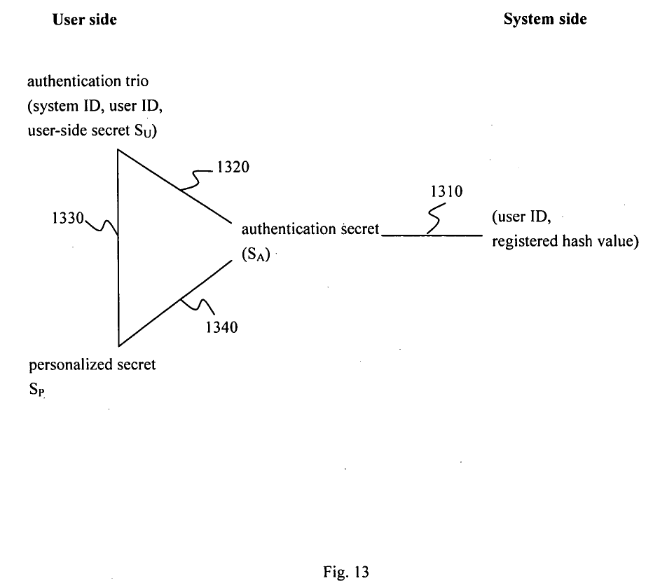

One feature of the described implementations is the deliberate design that establishes an association between a computer system and a user by an authentication secret. More specifically, an association is established between a system identifier and a user identifier through several links to the authentication secret. FIG. 13 illustrates these linkages. At the system site identified by a system identifier, a hash value is registered along with a user identifier, where the hash value is derived from the authentication secret. Based on this derivation and registration, the line 1310 indicates a linkage that links the authentication secret S_{A} with the user identifier. On the user side, an authenticator, which consists of a user-side secret S_{U}, the system identifier, and the user identifier, is kept in persistent memory. Derived from partitioning the authentication secret S_{A}, the user-side secret S_{U} has a relationship with the authentication secret S_{A}. Based on this relationship and the grouping of the three elements, the line 1320 indicates a linkage that links the authentication secret S_{A} with the system identifier and the user identifier. The two lines 1320 and 1330 indicate that the user-side secret S_{U} is derived from two independent inputs, S_{A} and S_{P}, while the two lines 1320 and 1340 indicate that S_{A} can be recovered from the two secrets S_{P} and S_{U}.

Though playing a central role in the linkages as illustrated in FIG. 13, the authentication secret does not exist persistently. This is accomplished by deleting this secret from every memory that is associated with the computations upon the ending of using it in the registration, user login, and update process.

In certain implementations, where the authentication secret is generated on the user side as illustrated in the registration step 220 of FIG. 2, the authentication secret never exists, persistently and transitorily, on the system side.

As a collective authenticator, the user login file simplifies the input. One may raise a question: Will loss of the user login file cause a security concern? In particular, a single identical personalized secret S_{P} may be used for accesses to all systems. Will this cause a further concern?

The mathematics in the following removes these concerns. Suppose that the user has registered at n systems. Then the user login file contains n user-side secrets S_{U}(1), S_{U}(2), . . . , S_{U}(n). With such information, n equations can be established as follows:

$$\begin{matrix}{S}_{U} ( 1 ) = f2 ( f1 ( {S}_{P} ) , {S}_{A} ( 1 ) ) = ( f1 ( {S}_{P} ) + α \times {S}_{A} ( 1 ) ) mod q ; \\ ⋮ \\ {S}_{U} ( n ) = f2 ( f1 ( {S}_{P} ) , {S}_{A} ( n ) ) = ( f1 ( {S}_{P} ) + α \times {S}_{A} ( n ) ) mod q ,\end{matrix}$$

In these n equations, there are n+1 unknown values: f1(S_{P}), S_{A}(1), . . . , S_{A}(n). These n+1 unknown numbers are independently generated. S_{A}(1), . . . , S_{A}(n) are random numbers or pseudorandom numbers. Also, f1(S_{P}) can be considered as a pseudorandom number because f1 is a collision-resistant hash function. Therefore, it is near impossible to solve the n equations for the n+1 independently and randomly generated unknown values (or generated in a pseudorandom way in practical implementations), assuming the modulus q is substantially larger than n (q>>n). The assumption is obviously applicable when q is chosen to be an integer at least as large as 2¹⁶⁰ as suggested earlier.

The personalized secret is independently selected at the discretion of its owner user. The secret S_{P} itself cannot be considered as a random number or a pseudorandom number. The value f1(S_{P}) can be regarded as such a number, however. The first transformation function f1 is preferably configured as a collision-resistant hash function, which can be configured as a mixing function with pseudorandom output: Given one part of the output but not the input, it is infeasible to predict another part of the output. Several collision-resistant hash functions satisfy such a property, including MD2, MD5, SHA-1, SHA-256, SHA-384, and SHA-512.

FIG. 13 further illustrates another exemplary method for digital authentication based on linking between a personalized secret and a randomly generated secret. In various implementations, these two secrets are both created on the user side. The personalized secret S_{P} is a user secret selected by an authorized user. The authentication secret S_{A} comprises a computer-generated secret; a user device operated by the authorized user creates a random or pseudorandom number as a part or the whole of this secret S_{A}. In the first task of the registration process as illustrated in FIG. 2, the device further uses a one-way hash function to compute a hash value from the authentication secret and registers the hash value, Hash(S_{A}), as a registered secret in a computer system, at which this user is authorized to register. The computer system is identified with a system ID as shown in both FIGS. 2 and 13.

As illustrated in FIGS. 3A and 3B, the user device further receives the personalized secret and transforms this secret into a transformed secret via a first transformation function f1, which is collision-resistant. The user device subsequently uses the transformed secret and the authentication secret as inputs to a second transformation function f2 to produce a second user secret S_{U}. In notations, S_{U}=f2(the transformed secret, the authentication secret)=f2(f1(S_{P}), S_{A})=(f1(S_{P})+α>S_{A}) mod q, where the parameters α and q are as defined earlier. The last step of the registration process comprises storing the second user secret S_{U} outside the computer system. S_{U} is one component of the authenticator trio or quadruple 350 in FIGS. 3A and 3B. Though it may be preferred to use a portable device to store the authenticator in some implementations, other implementations may use other methods to store the authenticator, e.g., using a networking server as the storage device.

After the registration as described above, the user is able to login the computer system. The login process comprises using a first user input and a second user input from a user requesting to access the computer system to initiate a challenge from the computer system and trigger the user side to produce a response. The challenge and response are utilized to compare the registered secret with a user-side hash value computed from the first and second user inputs. The comparison result enables the computer system to authorize the requested access when there is a match and to reject the requested access when there is not a match.

The login process can be carried out either on the same user device as that used for registration or on a different user device. Upon receiving the first and second user inputs, the login device uses the first transformation function f1 as defined for the registration to transform the first user input into a transformed user input; subsequently, the login device uses the transformed user input and the second user input as inputs to a third transformation function f3 to produce an output. As discussed in the U.S. patent application Publication 2005/0081041, the third transformation function f3 should have an inverse relationship with the second transformation function such that the authentication secret can be recovered. It is configured as the following: the output=f3(the transformed user input, the second user input)=(α⁻¹×(the second user input)+((−(α⁻¹×(the transformed user input) mod q)) mod q)) mod q, where α⁻¹ and q are as defined earlier. Next, the login device computes a hash value of the output of the third transformation function as the user-side hash value. The login device also receives a challenge from the computer system and uses the user-side hash value as the encryption key to encrypt the challenge as the response to the challenge to be sent to the computer system. Furthermore, the login device receives a decision from the system. The decision is access permission when the user-side hash value matches the registered secret; otherwise, the decision is a denial.

The chance of successfully guessing a randomly generated secret is purely a question on probability. Suppose that the secret is randomly generated as a bit string of 160 bits in size. The probability of a successful guess is 2⁻¹⁶⁰. Assuming the time for computing one guess is one micro-second (10⁻³ second), one can compute the expected time for one successful guess as being 10⁻³×2¹⁶⁰ seconds, which is about 10⁻³×10⁴⁸ seconds or more than 10³⁷ years. In other words, it is very unlikely or impossible to get a successful guess in reasonable time. Such extreme difficulty on guessing is true for both on-line and off-line attacks.

In an environment where a user is allowed to access different member systems among a plurality of computer systems, the authentication secrets associated with one particular user is a set of random or pseudorandom numbers. The generations of these numbers are independent events. Therefore, disclosure of one secret in the plurality of systems reveals no knowledge about the other secrets. This is one further benefit on the system side. In the conventional methods, a user may register one single identical secret with several systems; disclosure of such a secret forces the user to change the registered secret at all endangered systems.

Though the user registers at each system with a distinct secret, the user can use one identical personalized secret and one user login file to access several member systems among a plurality of systems. The identical personalized secret can be a user password. This is a convenience to the user.

On a user side, the user now has two secrets for accesses to one system: one personalized secret S_{P} and one user-side secret S_{U}. For accesses to members among a plurality of systems, the user has two secrets—one personalized secret and one personal login file, which as a whole is one secret. Separately safeguarding each of the two secrets significantly strengthens the security protection.

Now, let us consider implementations where the personalized secret is a user password. There are several advantages. Password-stealing Trojan horses without permission to access the personal login file will steal only half secret. Password stealing by utilizing other techniques like server spoofing or server compromise would also be difficult or impossible because password is not requested or stored in system sites.

Certain derivations of the password are not stored, either. Examples of such derivations include a hash value of the password, a cipher of the password, a transformation of the password through a single-input function where the password is the sole input to the function. The only stored value related to the password is the user-side secret that is derived from the composite transformation of the first and second transformations, which have two mutually independent inputs—the password and the authentication secret. This nice feature eliminates any clues to attackers with respect to the password. Without such clues, testing a guess through the cycle of challenge and response is the only way to decide whether the guess about the password is correct. Therefore, guess the password is as hard as guess the authentication secret S_{A} or the hash value Hash(S_{A}) of this secret, unless the corresponding user-side secret is utilized in the guess attempt.

In the described implementations, the user and system sides both share the responsibility of security protection. Conventionally, protection measures are primarily designed and implemented on the system side. In the described implementations, the user-side is the main focus of the security protection. A system site implemented in accordance with this patent specification is no distinction from a system site that has been functioning according to the existing password-based authentication methods. On the user side, the difference is substantial. Particularly, three transformation functions, f1, f2, and f3, are utilized on the user side.

Variations on configuring the three transformation functions are possible. For example, the first function f1 can be configured by adding a positive constant integer to a collision-resistant hash function, i.e. f1(S_{P})=Hash(S_{P})+β. Functions configured in this way remain a collision-resistant hash function. Such a parameter β may be device-specific, providing another layer of protection for confidentiality.

As designed in the second exemplary login process, the user-side validation technique is an action on the user-side but still provides a protection measure for the system side. With such an action, a legitimate user will send a valid response only in response to a challenge; consequently, the accessed system is capable of detecting any form of on-line guess attack at the beginning of an attack.

The validation on the user side is a check against a verifier that is accessible to the user processor on which the user performs a login. What is the verifier? In one implementation, for example, the user side stores Hash(Hash(S_{A})) as the verifier for the check; the authentication secret S_{A} is hashed twice and the double-hashed value is then stored in this user's personal login file.

Because the hash function herein is a one-way function, one cannot reverse the computation of the second hashing in Hash(Hash(S_{A})) to obtain the first hashed value from a double-hashed value. With such an implementation, disclosure of a user-side verifier from a client site does not compromise the security of a system site.

The user-side validation technique as devised can also be utilized in other user authentication methods and systems. The user-side verifier may be formulated in different manners for different types of method. For example, the verifier can be a public key in a public/private key pair when the user uses the pairing private key to create a digital signature as the response in response to a challenge. In this example, the system site uses the same public key as the system-side verifier. As a second example, the user-side verifier can be Hash²(the user-chosen password) for the conventional user authentication methods using password.

With user-side validation, the user side and the system side share the responsibility of validation. On the user site, the purpose of the validation is to ensure that the input to produce the response is valid. On the system side, the validation is to ensure that the access is from a legitimate user and not from an intruder.

A personal login file is a digital file held by its owner user. As illustrated in FIG. 4, each record of the file is associated with a respective system and contains three data items: (1) a system identifier of the system, (2) a user identifier that is this user's identification registered with the identified system, and (3) a user-side secret to establish a linkage that links a “hidden” authentication secret with the system identifier and the user identifier. In FIG. 5, each record further contains a double-hashed value as the user-side verifier. As illustrated in the two figures, every user-side secret and every double-hashed value are encoded as a non-negative integer.

More information may be added into the personal login file, including additional personal identification information such as birth date, address, and so forth. Additional information about the accessed system such as telephone numbers or persons for contact can also be included. As such, a personal login file can be used as a personal tool for organizing information related to accesses to member systems among a plurality of systems. Confidential information such as birth dates and others can be encrypted if necessary. A derivative of the personalized secret S_{P} can be used as the symmetric crypto-key for this purpose, because this secret S_{P} is not included in the personal login file. The validity of an input personalized secret is validated “indirectly” by verifying the recovered authentication secret. The user-side secret is one input to recover the authentication secret; therefore, it must be kept in plaintext form. So is the double-hashed value of the authentication secret. Nevertheless, disclosure of these secrets causes a much less concern as discussed earlier.

In implementations, the above described techniques and their variations may be implemented as computer software instructions. Such software instructions may be stored in an article with one or more machine-readable storage media or stored in one or more machine-readable storage devices connected to one or more processors. In operation, the instructions are executed by, e.g., one or more computer processors, to cause the machine to perform the described functions and operations. As more specific examples, the user side operations described above may be implemented as software on the user side computer or digital device which may be a client to a system server computer.

Only a few implementations and examples are described. However, other variations and implementations are possible based on what is described and illustrated in this application.

What is claimed is:

1. A method for digital authentication, comprising:
using a user device operated by an authorized user to produce and register a secret in a computer system; and
using a first user input and a second user input from a user requesting to access the computer system to initiate a challenge from the computer system and a response from the requesting user to compare the registered secret with a user-side hash value computed from the first and second user inputs to authorize the requested access when there is a match and to reject the requested access when there is not a match.

2. The method as in claim 1, wherein the registration of the secret comprises:
generating a random or pseudorandom number as an authentication secret;
using the authentication secret as an input to a one-way hash function to produce a hash value;
registering the hash value as the registered secret of the authorized user with the computer system;
selecting a personalized secret as a first user secret by the authorized user;
transforming the first user secret via a first transformation function into a transformed secret;
using the transformed secret and the authentication secret as inputs to a second transformation function to produce a second user secret; and
storing the second user secret outside the computer system.

3. The method as in claim 2, further comprising:
upon receiving the first and second user inputs from the user requesting the access, transforming the first user input via the first transformation function into a transformed user input;
using the transformed user input and the second user input as inputs to a third transformation function to produce an output;
computing a hash value of the output of the third transformation function as the user-side hash value;
using the user-side hash value as an encryption key; and
upon receiving a challenge from the computer system, using the encryption key to encrypt the challenge as the response to the challenge to be sent to the computer system.

4. The method as in claim 2, further comprising using a collision-resistant hash function as the first transformation function.

5. The method as in claim 2, further comprising configuring the second transformation function as f2(the transformed secret, the authentication secret)=(the transformed secret+α×(the authentication secret)) mod q, where the modulus q is a positive integer greater than all possible instances of the authentication secret and the parameter α is a positive integer relatively prime to q.

6. The method as in claim 2, wherein the personalized secret comprises a user-chosen password.

7. The method as in claim 2, wherein the personalized secret comprises a biological feature of the authorized user.

8. A user authentication method utilizing challenge and response comprising:
when a user requests an access to a computer system, using a first user input and a second user input from the user and a registered secret at the system to perform a challenge-and-response process to authorize or reject the access request.

9. The user authentication method of claim 8, further comprising a registration process including:
using an authentication secret as input to a one-way hash function to produce a hash value;
registering the hash value as the registered secret of the user with the computer system;
using a first user secret and the authentication secret as input to produce a second user secret; and
providing a persistent memory to store the second user secret;
whereby the registered secret on the system side and the first and second user secrets on the user side establish an association between the user and the computer system, and the challenge-and-response process is to challenge the user to reestablish the association.

10. The user authentication method of claim 9, wherein the first user secret comprises a user-selectable password.

11. The user authentication method of claim 9, wherein the first user secret comprises information digitalized from biological characteristics of the user.

12. The user authentication method of claim 9, wherein the first user secret comprises a concatenation of a user-selectable password and a device-specific code.

13. The user authentication method of claim 9, wherein the first user secret comprises a combination of a plurality of secrets.

14. The user authentication method of claim 9, wherein the challenge-and-response process comprises:
creating a message as a challenge by the computer system;
using a user station to receive the challenge sent from the computer system;
computing a user-side hash value from the first and second user inputs by the user station;
using the user-side hash value as an encrypting key to encrypt the received challenge by the user station to produce a response;
sending the response to the computer system from the user station;
using the registered secret as a decryption key to decrypt the received response by the computer system to produce a result; and
authorizing the access request when the result matches the challenge and rejecting the access request when the result mismatches the challenge.

15. The user authentication method of claim 14, wherein computing the user-side hash value comprises:
using the first and second user inputs to a transformation to produce a value as a recovered authentication secret;
using the recovered authentication secret as input to the one-way hash function to produce the user-side hash value; and
deleting the recovered authentication secret from the memory associated with the computations upon the production of the user-side hash value.

16. The user authentication method of claim 9, further comprising producing a random number as the authentication secret.

17. The user authentication method of claim 9, further comprising producing a pseudorandom number as the authentication secret.

18. The user authentication method of claim 8 further comprising using a system identifier to identify a computer system among a plurality of computer systems as the computer system to request for access.

19. The user authentication method of claim 18, further comprising using a user identifier as a pointer to retrieve the registered secret from a plurality of secrets registered with the identified computer system.

20. The user authentication method of claim 9, further comprising, upon termination of the registration process, deleting the authentication secret from each memory associated with computations.

21. The user authentication method of claim 9, further comprising changing the authentication secret and the first user secret to a new secret respectively and updating the registered secret and the second user secret accordingly.

22. The user authentication method of claim 9, further comprising changing the authentication secret to a new secret and updating the registered secret and the second user secret accordingly while keeping the first user secret unchanged.

23. The user authentication method of claim 9, further comprising updating the second user secret triggered by changing the first user secret to a new secret while keeping the authentication secret and the registered secret unchanged.

24. A method of user authentication, comprising:
using an authentication secret to associate a user identifier of a user with a system identifier of a computer system;
using a user password from the user and the authentication secret as input to produce a user-side secret;
grouping the user-side secret, user identifier, and system identifier as an authenticator; and
using the user password and the authenticator to reproduce the authentication secret by a user station to reestablish the association as a basis for authenticating the user to the computer system.

25. The method of user authentication of claim 24, wherein the authentication secret comprises a random number.

26. The method of user authentication of claim 24, further comprising:
using the authentication secret as input to produce a hash value; and
registering the hash value along with the user identifier of the user with the computer system.

27. The method of user authentication of claim 26 further comprising using the hash value on the system side in a challenge and response process to permit or deny an access request.

28. The method of user authentication of claim 24 further comprising including the authenticator as a member of a plurality of authenticators, each authenticator having a user-side secret, a user identifier of the user, and a system identifier.

29. The method of user authentication of claim 28 further comprising providing a device with persistent memory to store the plurality of authenticators.

30. The method of user authentication of claim 29 further comprising using the user password and the plurality of authenticators to authenticate the user to access any member of a plurality of computer systems.

31. The method of user authentication of claim 30, further comprising, on a user station:
using a system identifier input from the user to identify a member computer system to request for access.
using the system identifier input as a pointer to identify an authenticator among the plurality of authenticators;
using a password input from the user and the user-side secret from the identified authenticator as input to produce a value as a recovered authentication secret;
using the recovered authentication secret as input to produce a user-side hash value; and
using the user-side hash value in a challenge-and-response process to obtain an access permission or denial.

32. The method of user authentication of claim 31, wherein the challenge-and-response process results in an access permission when the recovered authentication secret matches the original authentication secret.

33. The method of user authentication of claim 31, wherein the challenge-and-response process results in an access denial when the password input mismatches the user password.

34. The method of user authentication of claim 26 further comprising updating the registered secret and the user-side secret by changing the authentication secret to a new secret while keeping the user password unchanged.

35. The method of user authentication of claim 26 further comprising updating the registered secret and the user-side secret by changing the authentication secret to a new secret and changing the user password to a new password.

36. The method of user authentication of claim 26 further comprising updating the user-side secret triggered by changing the user password to a new password while keeping the authentication secret unchanged.

37. A method of user authentication, comprising:
using a secret to link a user with a computer system;
in a login process, using a user-side verifier to verify whether the secret is used in processing an access request on the user side.

38. The method of claim 37, wherein the secret is a user-selectable password.

39. The method of claim 37, wherein the secret comprises either one of a random number and a pseudorandom number.

40. The method of claim 37, wherein the user-side verifier is a derivative of the secret.

41. The method of claim 37, wherein the user-side verifier is a double-hashed value of the secret.

42. The method of claim 37, further comprising sending the access request to the computer system only when the verification proves that the secret is used in the processing on the user side.

43. An article comprising a machine-readable medium that store machine-executable instructions for user authentication, the instructions causing a machine to:
send an access request to a computer system;
receive a challenge message from the computer system;
use a first user input, a second user input, and the challenge message as input to a transformation to produce a response message;
send the response message and a user identifier to the computer system; and
receive an access decision from the computer system, wherein the access decision, either a permission or a denial, is determined by the computer system according to a registered secret associated with the user identifier.

44. The article as in claim 43, wherein the instructions further cause a machine, at a registration time, to:
receive an identifier from a user as the user identifier;
produce an authentication secret;
produce a hash value from the authentication secret;
register the hash value as the registered secret along with the user identifier with the computer system;
use a user password and the authentication secret as input to produce a user-side secret; and
store the user-side secret in a persistent memory.

45. The article as in claim 44, wherein the access decision determined by the accessed computer system is a denial when the first user input mismatches the user password.

46. The article in claim 44, wherein the instructions further cause a machine to change the authentication secret to a new secret and update the registered secret and the user-side secret accordingly.

47. The article in claim 44, wherein the instructions further cause a machine to update the user-side secret by changing the user password to a new password while keeping the authentication secret and the registered secret unchanged.
